(19) United States
(12) Patent Application Publication
(10) Pub. No.: US 2004/0029468 A1
(43) Pub. Date: Feb. 12, 2004

(54) Side curtain typed airbag, and a process of preparing for the same

(76) Inventors: Kwang-Oh Kim, Kyongsangbuk-do (KR); Sang-Mok Lee, Kyongsangbuk-do (KR)

Correspondence Address: BIRCH STEWART KOLASCH & BIRCH, PO BOX 747, FALLS CHURCH, VA, 22040-0747, US

(21) Appl. No.: 10/450,617

(22) PCT Filed: Oct. 25, 2001
(86) PCT No.: PCT/KR01/01804

(30) Foreign Application Priority Data
Jan. 9, 2001 (KR) 2001/1070
Apr. 19, 2001 (KR) 2001/20974

(51) Int. Cl. B32B 5/22; B29D 23/00; B29D 22/00; B60R 21/16; B32B 5/18

(52) U.S. Cl. 442/76; 428/34.1; 280/728.1

(57) ABSTRACT

The present invention relates to a side curtain typed air bag in order to prevent passengers from being injured by a side glass window or structure of a vehicle in the event of a rollover or rolling of the vehicle. The side curtain typed air bag of the present invention is characterized in that the upper and lower portions of air bag consisting of thermoplastic multi-filaments are combined by sewing, and a rubber component is coated or an adhesive film is laminated on upper portions and/or lower portions of air bag including sewing portion, an air leak amount per unit length of the sewing portion (measured at pressure of 2.5 KPa) is less than 0.8L/min. cm. The air bag of the present invention can safely protect passengers in the event of a rollover of the vehicle by suppressing the air leak.

### TECHNICAL FIELD

The present invention relates to an air bag installed in a side glass window or structure of a vehicle (hereinafter, referred to as “a side curtain typed air bag”) in order to protect passengers against impact in the event of a side collision and to prevent them being bumped with a side glass window or structure of the vehicle, and a process of preparing the same.

In general, a rubber component such as silicone rubber, chloroprene rubber or the like is uniformly coated on fabrics, which is then cut and sewn to prepare an air bag. A common air bag installed at the front of a vehicle should be quickly inflated by an explosive gas in the event of a collision and then the gas in the inflated air bag should be discharged within a short time period in order to minimize the second impact of passenger applied by the inflated air bag and to ensure the driver's visual field. For this reason, vents for leaking air are provided in most of conventional air bags which are installed at the front of a vehicle.

Since a side curtain typed air bag is to protect passengers against side windows or structures of a vehicle in the event of a rollover or rolling of the vehicle, the inflation state of the side curtain typed air bag should be maintained during several seconds, more properly more than 5 seconds, when the vehicle is rolling in order to securely hold up the head of passengers. For this purpose, more gas than is necessary should not leak from fabrics and sewing portions of the inflated air bag.

So there is no vent for leaking air in general side curtain typed air bag.

### BACKGROUND ART

U.S. Pat. No. 5,685,347 proposes a method of weaving on a Jacquard loom the upper and lower fabrics simultaneously of an air bag in order to prevent too much air leaking from sewing portions of the air bag. However, this method has problems that it needs an Jacquard loom equipped with expensive electronic devices and it is very complicated to program or input weaving patterns into such loom.

Further, air bags prepared by this method also have problems that connecting portions of the fabrics are so weak that a gap is generated at the connecting portions when air bag is inflated and thus air leaks through the gap, and that the connecting portions are weak in strength.

In addition, Japanese laid-Open Publication Hei 4-81342, Hei 4-197848, Hei 3-10946 etc., propose methods of sealing an air bag, which comprise sewing the fabrics coated with a rubber component to prepare an air bag, and closing up the sewing portions of the air bag with tape. However, these methods have problems such that, since an additional sealing process is added, the process thereof becomes complicated and the production cost increases.

Meanwhile, a method of preparing a side curtain typed air bag by sewing fabrics coated with silicon rubber, in which sewing portions are not sealed is proposed. However it is not suitable to side curtain typed air bag due to high air leak amount per unit length of sewing portion.

The above mentioned prior side curtain typed air bag has an air leak amount per unit length of sewing portions of about 0.9 L/min•cm (measured at a pressure of 2.5 KPa) and thus it cannot last its inflated state for more than 5 seconds. So it is impossible to protect passengers safely.

### DISCLOSURE OF THE INVENTION

An object of the present invention is to provide a method of preparing a side curtain typed air bag with less than 0.8L/min•cm of air leak amount per unit length of the sewing portion.

Another object of the present invention is to provide a side curtain typed air bag for preventing passengers being bumped with side glass windows, etc. of an vehicle, by suppressing air leak from an inflated air bag to maintain the inflated state for at least 5 seconds, even without any separate sealing process of sewing portions.

The side curtain typed air bag of the present invention, characterized in that the upper and lower portions of air bag consisting of thermoplastic multi-filaments are combined by sewing, and a rubber component is coated or an adhesive film is laminated on upper portions and/or lower portions of air bag including sewing portion, an air leak amount per unit length of the sewing portion (measured at a pressure of 2.5 KPa) is less than 0.8L/min•cm.

The method of preparing a side curtain typed air bag of the present invention characterized in that sew non-coated or non-laminated fabrics consisting of thermoplastic multi filament to the form of air bag, and then coat a rubber component or laminate an adhesive film on the upper portions and/or lower portions of the sewed air bag.

In below, the present invention is illustrated in details by referring the drawings attached.

The side curtain typed air bag of the present invention could be mede by several methods as below.

The first method of the present invention, cut the fabrics woven by thermoplastic multi filament (herein after we call it as “fabric for air bag”) to the upper and lower portions of air bag, and then sew the fabrics to the form of air bag.

In such case, it is possible to use polyamide multi filament, polyester multi filament or the like as the thermoplastic multi filament of fabric, but it is more preferable to use polyamide multi filament with 240˜420 denier.

Since the air bag of the present invention is mounted at the side of vehicles, it is preferable to have a less volume. Therefore fineness of the thermoplastic multi filament is preferably 210˜420 denier.

And then, coat a rubber component or laminate an adhesive film on the upper portions and/or lower portions of sewed air bag.

As to rubber components, it is possible to use silicone rubber, chloroprene rubber, urethane rubber or the like, but it is more preferable to use emulsion typed silicone rubber for easy coating.

The silicone rubber can be coated on upper portions and/or lower portions of air bag by knife coating method, dipping method or spray method. But coating method, and dipping method are more preferable than knife coating method for continuous process.

As to rubber components, it can include chloroprene rubber, silicone rubber, urethane rubber or the like. The coating amount of rubber component per unit area of the air bag is preferably 15˜200 g/m².

When the coating amount of rubber component per unit area of the air bag is less than 15 g/m², it is impossible to maintain the inflation state of the side curtain typed air bag during more than Second because air leak amount becomes increase. When the coating amount exceeds 200 g/m², problems arise that the hardening time becomes long and the volume of the air bag increase.

Meanwhile, it is possible to laminate adhesive film on the upper and/or lower portion of air bag instead of coating rubber component.

The adhesive film could be composed of polyurethane resin, polyether resin, polypropylene resin, polyethylene resin, polyamide resin or copolymer of above mentioned resins.

The thickness of adhesive film is preferably 5˜100 μm. When the thickness is less than 5 μm, air leak amount per unit length of the sewing portion becomes increase. When the thickness is more than 100 μm, folding property in module becomes deteriorated.

The second method of the present invention, fold more than two fabrics woven by thermoplastic multi filament, and then sew them to the several forms of air bag.

Specifically, fold the fabrics with original width before coating and cutting, and then sew them to the several forms of air bag such as FIG. 1.

It is more preferable to sew the fabrics by CAD functional sewer.

The kinds and fineness of multi filament in fabric are same as those of the above-mentioned first method.

Continuously, coat a rubber component or laminate an adhesive film on the sewed fabric (1) as FIG. 1, and then cut the fabric along sewing line (2) for side curtain typed air bag.

The kinds of rubber component, coating amount per unit area, method of coating and kinds or thickness of the adhesive film are same as those of the above-mentioned first method.

The present invention characterized in that sew the fabrics for air bag, and then coat a rubber component or laminate an adhesive film on the upper portion and/or lower portion of sewed air bag.

Specifically, the present invention characterized in that sew the non-coated or non-laminated fabrics to the form of air bag, and than coat a rubber component or laminate an adhesive film on the air bag.

The present invention has an effect of doing the coating process and sealing process simultaneously because it coat rubber component or laminate adhesive film on all the surface of air bag including sewing portion.

As a result, the process of the present invention becomes simple and the cost of the present invention becomes low.

The air bag of the present invention has an air leak amount of less than 0.8L/min•cm measured as a pressure of 2.5 KPa per unit length of sewing portion because its sewing portion is coated with rubber component or laminated with adhesive film.

Therefore, the air bag of the present invention would protect passengers in a vehicle more effectively since it the inflating state of the air bag can be maintained for at least 5 minute in the event of a rollover or rolling of the vehicle.

In the present invention, the air leak amount per unit length of sewing portions is determined by a measuring apparatus equipped with a regulator, a flow meter and a pressure meter.

Specifically, the leak test comprises inflating an air bag completely by introducing an air under the pressure of 2.5 KPa into an air bag, and measuring the amount (L) of air leaking from the air bag per unit period (1 minute), which is divided by total length (cm) of the sewing portions of the air bag to obtain the air leak amount per unit length of sewing portions. In the test, it is assumed that the air leak amount is zero (0 L) from fabrics of the air bag other than the sewing portions.

### BRIEF DESCRIPTION OF THE DRAWINGS

FIG. 1 is a plane view of the sewn side curtain type air bag fabrics according to the present invention which is not treated cutting process.

FIG. 2 is a plan view of the side curtain type air bag according to the present invention which is laminated with adhesive film.

FIGS. 3(a)˜3(c) is a cross section view of the A-A′ part in FIG. 2.

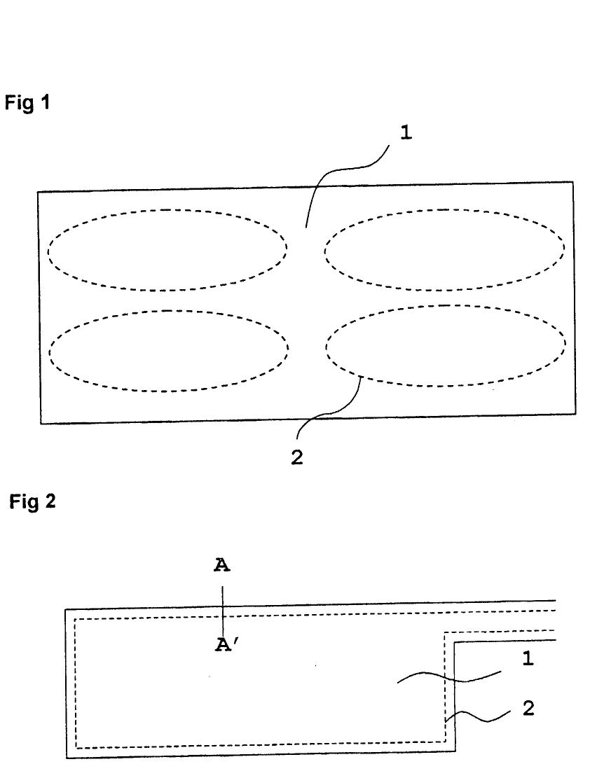

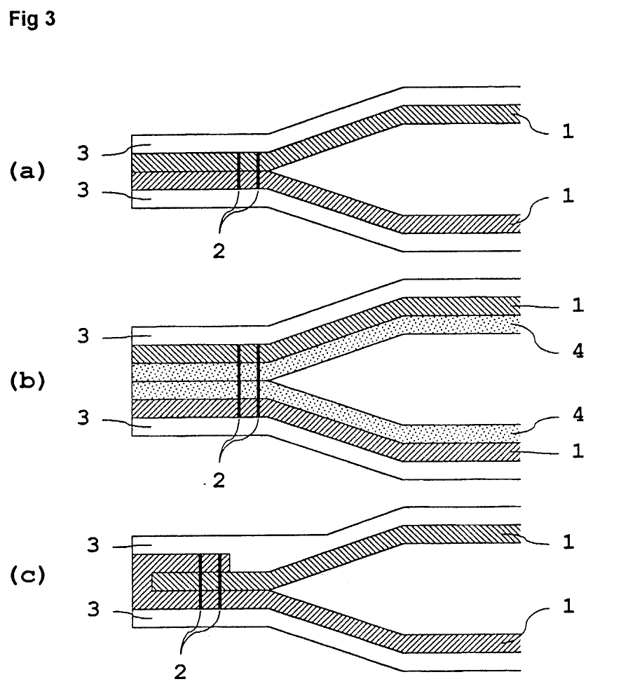

In the above drawings, symbol 1 represents air bag fabrics, symbol 2 represents sewing portions, symbol 3 represents adhesive film, and symbol 4 represents silicone rubber.

### BEST MODE FOR CARRYING OUT THE INVENTION

The present invention will be more specifically illustrated by using the following Examples and Comparative Examples, but the present invention does not limited to these Examples.

### EXAMPLE 1

Plane fabric with density of 76 filament/inch×72 filament/inch is prepared by weaving the warp and weft of polyamide 66 210 denier filament, and by scouring and heat setting the woven fabric. After cutting thus prepared fabrics to the upper and lower portions of air bag, and then sewing them to side curtain typed air bag. After coating emulsion silicone resin (coating amount: 35 g/m²) on the upper and lower portion of air bag by spray methods, and then drying and curing then for a side curtain typed air bag. Thus prepared air bag has an air leak amount per unit length of sewing portion of the air bag of 0.45L/min•cm measured at a pressure of 2.5 KPa.

### EXAMPLE 2

Plane fabric with density of 60 filament/inch×60 filament/inch is prepared by weaving the warp and weft of polyamide 66 315 denier filament, and by scouring and heat setting the woven fabric. After cutting thus prepared fabrics to the upper and lower portions of air bag, and then sewing them to side curtain typed air bag. After coating emulsion silicone resin (coating amount: 25 g/m²) on the upper and lower portion of air bag by knife coating methods, and then drying and curing then for a side curtain typed air bag. Thus prepared air bag has an air leak amount per unit length of sewing portion of the air bag of 0.63L/min•cm measured at a pressure of 2.5 KPa.

### EXAMPLE 3

Plane fabric with density of 49 filament/inch×49 filament/inch is prepared by weaving the warp and weft of polyamide 66 420 denier filament, and by scouring and heat setting the woven fabric. After cutting thus prepared fabrics to the upper and lower portions of air bag, and then sewing them to side curtain typed air bag. After coating emulsion silicone resin (coating amount: 35 g/m²) on the upper and lower portion of air bag by dipping methods, and then drying and curing then for a side curtain typed air bag. Thus prepared air bag has an air leak amount per unit length of sewing portion of the air bag of 0.39L/min•cm measured at a pressure of 2.5 KPa.

### EXAMPLE 4

Plane fabric with density of 49 filament/inch×49 filament/inch is prepared by weaving the warp and weft of polyamide 66 420 denier filament, and by scouring and heat setting the woven fabric. After cutting thus prepared fabrics to the upper and lower portions of air bag, and then sewing them to side curtain typed air bag. After laminating film of polyurethane resin (thickness: 30 μm) on the upper and lower portion of air bag, and then drying and curing then for a side curtain typed air bag. Thus prepared air bag has an air leak amount per unit length of sewing portion of the air bag of 0.39 L/min•cm measured at a pressure of 2.5 KPa.

### EXAMPLE 5

Plane fabric with density of 70 filament/inch×70 filament/inch is prepared by weaving the warp and weft of polyamide 66 210 denier filament, and by scouring and heat setting the woven fabric. After folding the woven fabrics and sewing several side curtain typed air bags on the all width of the fabric. After coating silicone rubber (coating amount: 35 g/m²) on the all surface of sewed fabric by knife coater, and then cutting them along sewing line for a side curtain typed air bag. Thus prepared air bag has an air leak amount per unit length of sewing portion of the air bag of 0.45 L/min•cm measured at a pressure of 2.5 KPa.

### EXAMPLE 6

Plane fabric with density of 60 filament/inch×60 filament/inch is prepared by weaving the warp and weft of polyamide 66 315 denier filament, and by scouring and heat setting the woven fabric. After folding the woven fabrics and sewing several side curtain typed air bags on the all width of the fabric. After coating emulsion silicone resin (coating amount: 55 g/m²) on the all surface of sewed fabric by spray method, and then cutting them along sewing line for a side curtain typed air bag. Thus prepared air bag has an air leak amount per unit length of sewing portion of the air bag of 0.43 L/min•cm measured at a pressure of 2.5 KPa.

### EXAMPLE 7

Plane fabric with density of 49 filament/inch×49 filament/inch is prepared by weaving the warp and weft of polyamide 66 420 denier filament, and by scouring and heat setting the woven fabric. After folding the woven fabrics and sewing several side curtain typed air bags on the all width of the fabric. After coating emulsion silicone resin (coating amount: 65 g/m²) on the all surface of sewed fabric by dipping method, and then cutting them along sewing line for a side curtain typed air bag. Thus prepared air bag has an air leak amount per unit length of sewing portion of the air bag of 0.40 L/min•cm measured at a pressure of 2.5 KPa.

### EXAMPLE 8

Plane fabric with density of 49 filament/inch×49 filament/inch is prepared by weaving the warp and weft of polyamide 66 420 denier filament, and by scouring and heat setting the woven fabric. After folding the woven fabrics and sewing several side curtain typed air bags on the all width of the fabric. After laminating polyester film (thickness: 40 μm) on the all surface of sewed fabric, and then cutting them along sewing line for a side curtain typed air bag. Thus prepared air bag has an air leak amount per unit length of sewing portion of the air bag of 0.40 L/min•cm measured at a pressure of 2.5 KPa.

### COMPARATIVE EXAMPLE 1

Plane fabric with density of 70 filament/inch×70 filament/inch is prepared by weaving the warp and weft of polyamide 66 210 denier filament, and by scouring and heat setting the woven fabric. After coating silicone rubber on the prepared fabric by knife coater (coating amount: 35 g/m²). After cutting the coated fabric to the upper and lower portion of side curtain typed airbag, and sewing them for a side curtain typed air bag. Thus prepared air bag has an air leak amount per unit length of sewing portion of the air bag of 0.86 L/min•cm measured at a pressure of 2.5 KPa.

### COMPARATIVE EXAMPLE 2

Plane fabric with density of 60 filament/inch×60 filament/inch is prepared by weaving the warp and weft of polyamide 66 315 denier filament, and by scouring and heat setting the woven fabric. After coating silicone rubber on the prepared fabric by knife coater (coating amount 30 g/m²). After cutting the coated fabric to the upper and lower portion of side curtain typed airbag, and sewing them for a side curtain typed air bag. Thus prepared air bag has an air leak amount per unit length of sewing portion of the air bag of 0.88 L/min•cm measured at a pressure of 2.5 KPa.

### COMPARATIVE EXAMPLE 3

Plane fabric with density of 49 filament/inch×49 filament/inch is prepared by weaving the warp and weft of polyamide 66 420 denier filament, and by scouring and heat setting the woven fabric. After coating silicone rubber on the prepared fabric by knife coater (coating amount: 35 g/m²). After cutting the coated fabric to the upper and lower portion of side curtain typed airbag, and sewing them for a side curtain typed air bag. Thus prepared air bag has an air leak amount per unit length of sewing portion of the air bag of 0.93 L/min•cm measured at a pressure of 2.5 KPa.

### COMPARATIVE EXAMPLE 4

Plane fabric with density of 70 filament/inch×70 filament/inch is prepared by weaving the warp and weft of polyamide 66 210 denier filament, and by scouring and heat setting the woven fabric. After coating silicone rubber on the prepared fabric by knife coater (coating amount: 35 g/m²). After cutting the coated fabric, and sewing them for a side curtain typed air bag. Thus prepared air bag has an air leak amount per unit length of sewing portion of the air bag of 0.86 L/min•cm measured at a pressure of 2.5 KPa.

### INDUSTRIAL APPLICABILITY

Since the side curtain typed air bag of the present invention can maintain its inflated state for at least 5 seconds, it is very useful as an air bag mounted in a side window or structure of a vehicle in order to protect passengers in the event of a rollover or rolling of the vehicle.

Further, since the present invention can omit sealing process, the process of the present invention becomes simple.

What is claimed is:

1. A method of preparing a side curtain typed air bag, characterized in that sew non-coated or non-laminated fabrics consisting of thermoplastic multi filament to the form of air bag, and then coat a rubber component or laminate an adhesive film on the upper portions and/or lower portions of the sewed air bag.

2. The method according to claim 1, characterized in that the rubber component is silicone rubber, chloroprene rubber or urethane rubber.

3. The method according to claim 1, characterized in that the silicone rubber is coated on upper portion and/or lower portion of the sewed air bag by spray method.

4. The method according to claim 1, characterized in that the silicone rubber is coated on upper portion and/or lower portion of the sewed air bag by knife coating method.

5. The method according to claim 1, characterized in that the silicone rubber is coated on upper portion and/or lower portion of the sewed air bag by dipping method.

6. The method according to claim 1, characterized in that the coating amount of rubber component is 15 g/m²˜200 g/m².

7. The method according to claim 1, characterized in that cut the fabrics to the upper and lower portion of air bag before sewing.

8. The method according to claim 1, characterized in that cut the fabric for a side curtain typed air bag after sewing the folded fabric with full width to several form of air bag and coating rubber component or laminating adhesive film on the sewed fabric.

9. The method according to claim 1, characterized in that the thickness of adhesive film is 5˜100 μm.

10. The method according to claim 1, characterized in that the adhesive film is composed of polyurethane resin, polyether resin, polypropylene resin, polyethylene resin, polyamide resin or copolymer of above mentioned resins.

11. A side curtain typed air bag, characterized in that the upper and lower portions of air bag consisting of thermoplastic multi-filaments are combined by sewing, and a rubber component is coated or an adhesive film is laminated on upper portions and/or lower portions of air bag including sewing portion.

12. The side curtain typed air bag according to claim 11, an air leak amount per unit length of the sewing portion (measured at a pressure of 2.5 KPa) is less than 0.8L/min•cm.

13. The side curtain typed air bag according to claim 11, the sewing portion is coated with silicone rubber.

14. The side curtain typed air bag according to claim 11, the thickness of adhesive film is 5˜100 μm.

15. The side curtain typed air bag according to claim 11, the adhesive film is composed of polyurethane resin, polyether resin, polypropylene resin, polyethylene resin, polyamide resin or copolymer of above mentioned resins.
